(19) United States
(12) Patent Application Publication
(10) Pub. No.: US 2004/0156264 A1
(43) Pub. Date: Aug. 12, 2004

(54) Downhole telemetry system using discrete multi-tone modulation in a wireless communication medium

(75) Inventors: Wallace R. Gardner, Houston, TX (US); Vimal V. Shah, Sugar Land, TX (US); Paul F. Rodney, Spring, TX (US); Donald G. Kyle, Plano, TX (US)

Correspondence Address: CONLEY ROSE, P.C., P. O. BOX 3267, HOUSTON, TX, 77253-3267, US

(73) Assignee: Halliburton Energy Services, Inc., Houston, TX

(21) Appl. No.: 10/364,169

(22) Filed: Feb. 10, 2003

(51) Int. Cl. H04H 9/00

(52) U.S. Cl. 367/81

(57) ABSTRACT

A communication system usable in a borehole in which a downhole modem wirelessly communicates with a surface modem using discrete multi-tone (“DMT”) modulation. The communication may be one-way (i.e., from downhole modem to surface modem, or vice versa) or two-way between the two modems.

### CROSS-REFERENCE TO RELATED APPLICATIONS

This application contains subject matter that may be related to copending application titled “Downhole Telemetry System Having Discrete Multi-Tone Modulation And Dynamic Bandwidth Allocation,” Ser. No. 09/775,093, filed Feb. 1, 2001, incorporated herein by reference. This application contains subject matter that also may be related to copending application titled “Low Frequency Electromagnetic Telemetry System Employing High Cardinality Phase Shift Keying,” Ser. No. 10/190,165, filed Jul. 5, 2002, incorporated herein by reference.

### STATEMENT REGARDING FEDERALLY SPONSORED RESEARCH OR DEVELOPMENT

Not applicable.

### BACKGROUND OF THE INVENTION

1. Field of the Invention

The present invention generally relates to high speed digital data communications for use, for example, in downhole telemetry. More particularly, the invention relates the use of a discrete multi-tone (“DMT”) modulation technique in a wireless medium (e.g., electromagnetic, acoustic) associated with downhole telemetry. More particularly still, the invention relates to the use of DMT with dynamically adaptive operating characteristics to provide wireless telemetry capability that adapts itself to the environment in which the telemetry is being used.

2. Background Information

Modern petroleum drilling and production operations demand a great quantity of information relating to parameters and conditions downhole. Such information typically includes characteristics of the earth formations traversed by the wellbore, along with data relating to the size and configuration of the borehole itself The collection of information relating to conditions downhole, which commonly is referred to as “logging”, can be performed by several methods.

In conventional oil well wireline logging, a probe or “sonde” housing formation sensors is lowered into the borehole after some or all of the well has been drilled, and is used to determine certain characteristics of the formations traversed by the borehole. The upper end of the sonde is attached to a conductive wireline that suspends the sonde in the borehole. Power is transmitted to the sensors and instrumentation in the sonde through the conductive wireline. Similarly, the instrumentation in the sonde communicates information to the surface by electrical signals transmitted through the wireline.

An alternative method of logging is the collection of data during the drilling process. Collecting and processing data during the drilling process eliminates the necessity of removing or tripping the drilling assembly to insert a wireline logging tool. It consequently allows the driller to make accurate modifications or corrections as needed to optimize performance while minimizing down time. Designs for measuring conditions downhole including the movement and location of the drilling assembly contemporaneously with the drilling of the well have come to be known as “measurement-while-drilling” techniques, or “MWD”. Similar techniques, concentrating more on the measurement of formation parameters, commonly have been referred to as “logging while drilling” techniques, or “LWD”. While distinctions between MWD and LWD may exist, the terms MWD and LWD often are used interchangeably. For the purposes of this disclosure, the term MWD will be used with the understanding that this term encompasses both the collection of formation parameters and the collection of information relating to the movement and position of the drilling assembly.

Sensors or transducers typically are located at the lower end of the drill string in MWD systems. While drilling is in progress these sensors continuously or intermittently monitor predetermined drilling parameters and formation data and transmit the information to a surface detector by some form of telemetry. Typically, the downhole sensors employed in MWD applications are positioned in a cylindrical drill collar that is positioned close to the drill bit. The MWD system then employs a system of telemetry in which the data acquired by the sensors is transmitted to a receiver located on the surface. There are a number of telemetry systems in the prior art which seek to transmit information regarding downhole parameters up to the surface without requiring the use of a wireline. Of these, the mud pulse system is one of the most widely used telemetry systems for MWD applications.

The mud pulse system of telemetry creates “acoustic” pressure signals in the drilling fluid that is circulated under pressure through the drill string during drilling operations. The information that is acquired by the downhole sensors is transmitted by suitably timing the formation of pressure pulses in the mud stream. The information is received and decoded by a pressure transducer and computer at the surface.

In a mud pressure pulse system, the drilling mud pressure in the drill string is modulated by means of a valve and control mechanism, generally termed a pulser or mud pulser. The pulser is usually mounted in a specially adapted drill collar positioned above the drill bit. The generated pressure pulse travels up the mud column inside the drill string at the velocity of sound in the mud. Depending on the type of drilling fluid used, the velocity may vary between approximately 3000 and 5000 feet per second. The rate of transmission of data, however, is relatively slow due to pulse spreading, distortion, attenuation, modulation rate limitations, and other disruptive forces, such as the ambient noise in the drill string. A typical pulse rate is on the order of a pulse per second (1 Hz), which is generally inadequate for modem requirements.

### BRIEF SUMMARY OF THE PREFERRED EMBODIMENTS OF THE INVENTION

The preferred embodiments of the present invention solve the problems noted above by implementing a communication system in a borehole in which a downhole modem wirelessly communicates with a surface modem using discrete multi-tone (“DMT”) modulation. The communication may be one-way (i.e., from downhole modem to surface modem, or vice versa) or two-way between the two modems.

In accordance with a preferred embodiment, a downhole telemetry system comprises a surface modem coupled to an antenna and a downhole modem also coupled to an antenna. The downhole modem may wirelessly communicate with the surface modem using discrete multi-tone modulation to wirelessly transmit telemetry data over a set of frequency subchannels allocated for uplink communications. The wireless signals may be electromagnetic or acoustic. In general, any form of wireless device is permitted.

In accordance with a preferred embodiment of the modem, the modem comprises a constellation encoder, a modulator coupled to the constellation encoder, and a driver coupled to the modulator. The modem is adapted to wirelessly communicate with another modem via electromagnetic or acoustic signals using discrete multi-tone modulation to wirelessly transmit telemetry data over a set of frequency subchannels.

In accordance with another embodiment of the modem, the modem comprises a demodulator and a constellation decoder coupled to the demodulator. The modem is adapted to wirelessly receive, from another modem, electromagnetic or acoustic signals containing information that has been discrete multi-tone modulated using a set of frequency subchannels.

The wireless DMT-based communication system described herein may also be optimized during a configuration process during which the transmission capabilities of the wireless communication medium are quantified and an optimal number of data bits assigned to each of the DMT's subchannel frequencies is determined.

The preferred embodiments described herein provide increased telemetry data rates compared to conventional techniques for transmitting data in a well borehole, as well as increased reliability. The increase in reliability stems from optimally configuring the transmission mechanism based on actual measured attenuation conditions present in the borehole transmission channel. These and other aspects and benefits of the preferred embodiments of the present invention will become apparent upon analyzing the drawings, detailed description and claims, which follow.

### BRIEF DESCRIPTION OF THE DRAWINGS

For a detailed description of the preferred embodiments of the invention, reference will now be made to the accompanying drawings in which:

FIG. 1 depicts a quadrature amplitude modulation (“QAM”) constellation usable for modulating data;

FIG. 2 includes a block diagram of a conventional QAM encoder;

FIG. 3 illustrates the basic principle of discrete multi-tone (“DMT”) modulation;

FIG. 4 is a schematic view of an oil well in which a DMT-based, wireless telemetry system may be employed;

FIG. 5 shows a downhole tool used in wireless telemetry and employing DMT modulation;

FIG. 6A shows a block diagram of a preferred embodiment of the communication system employing DMT modulation using electromagnetic signals;

FIG. 6B shows a block diagram in which acoustic signals are used;

FIG. 7 is a block diagram of a transmitter which implements DMT modulation;

FIG. 8 shows a preferred embodiment of an inverse discrete Fourier transformer (“IDFT”) usable in the transmitter of FIG. 7;

FIG. 9 is a block diagram of a receiver which receives and demodulates DMT modulated data from the transmitter of FIG. 7;

FIG. 10 shows a preferred embodiment of a discrete Fourier transformer (“DFT”) usable in the receiver of FIG. 9; and

FIG. 11 shows a preferred process for initializing modems used in the DMT-based, electromagnet telemetry system described herein.

### NOTATION AND NOMENCLATURE

Certain terms are used throughout the following description and claims to refer to particular system components. As one skilled in the art will appreciate, various companies may refer to a component and sub-components by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either a direct or indirect physical connection. Thus, if a first device couples to a second device, that connection may be through a direct physical connection, or through an indirect physical connection via other devices and connections. The term “wireless” refers to any form of communication that does not use conductors. Wireless signals may include, without limitation, electromagnetic signals and acoustic signals.

To the extent that any term is not specially defined in this specification, the intent is that the term is to be given its plain and ordinary meaning.

### DETAILED DESCRIPTION OF THE PREFERRED EMBODIMENTS

The preferred embodiment described below uses discrete multi-tone (“DMT”) modulation to transmit information via a wireless communication channel between a downhole electronics package and surface electronics. A brief explanation of DMT modulation is provided below, followed by its application to the downhole data telemetry context. Additional information regarding DMT modulation can be found in a variety of resources such as Chapter 6 of “ADSL/VDSL Principles—A Practical and Precise Study of Asymmetric Digital Subscriber Lines and Very High Speed Digital Subscriber Lines,” by D. Rauschmayer (1999), incorporated herein by reference.

Data can be sent from a transmitter to a receiver over a communications channel in accordance with a variety of communication techniques. Generally, the transmitter includes a modulator and the receiver includes a demodulator. One type of modulator converts digital input bits into waveforms to be sent over the communication channel. The demodulator in the receiver generally reverses the process used by the modulator to recover the original bits (hopefully error-free) from the waveform.

One type of modulation technique is called quadrature amplitude modulation (“QAM”). QAM utilizes a sine wave and a cosine wave having the same frequency to convey information. As is well known, sine and cosine waves are periodic waveforms that are out of phase with respect to each other by 90 degrees. The waves are sent over a single channel simultaneously, and the amplitude, including sign and magnitude, of each wave conveys the information (bits) being sent. At least one period, and sometimes more, of the waves is sent to convey a set of bits before a new set of bits can be sent. New magnitudes for the sine and cosine waves are used to convey each new set of bits.

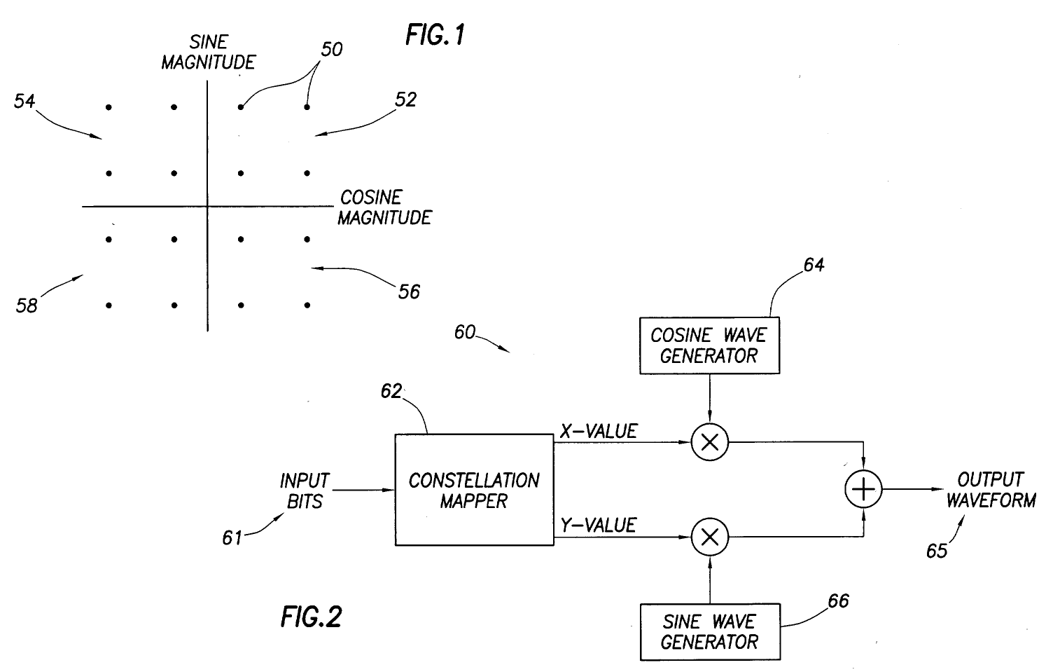

QAM uses a “constellation” of points to encode the input bits. Referring to the exemplary constellation of FIG. 1, 16 points (labeled with reference numeral 50) are shown in the constellation. The constellation is shown with reference to x-y axes. The x-axis represents the magnitude of the cosine wave and the y-axis represents the magnitude of the sine wave. Thus, each point 50 in the constellation has a cosine component and a sine component. The constellation is divided into four quadrants 52, 54, 56, and 58, and in the example of FIG. 1, there are four constellation points 50 in each quadrant.

The QAM constellation shown in FIG. 1 can be used to encode four bits of information (called a “symbol”). The four bits of information to be transmitted are mapped to 1 of the 16 points in the QAM constellation. There are 16 different values possible for a four bit binary number and thus a 16 point constellation provides a unique mapping for each four-bit symbol.

FIG. 2 shows a typical block diagram of a constellation encoder 60 useful for QAM. The input bits 61 are provided to a constellation mapper 62 which matches the input value to one of the points in the constellation. The constellation mapper generates an x-value and a y-value that correspond to the amplitude (including sign) of the cosine and sine waves of the point from the constellation to which the input bit value matches. The x-value is mixed with a cosine wave provided by cosine wave generator 64 and the y-value is mixed with a sine wave provided by sine wave generator 66. The two mixed cosine and sine waves then are added to produce an output waveform 65.

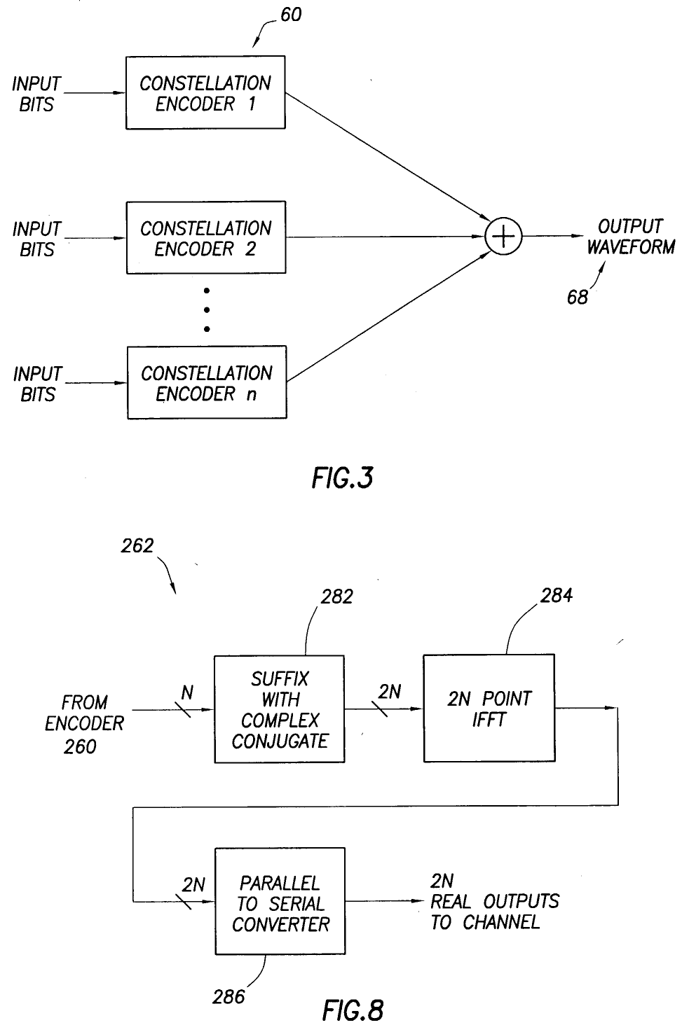

DMT modulation is an extension of the QAM. Whereas QAM involves a single cosine/sine waveform pair, DMT modulation involves the use of multiple cosine/sine waveform pairs, each pair using a different frequency than the other pairs. Each pair of cosine and sine waves encodes a different set of input bits, thereby providing the ability to transmit more information than in QAM in the same amount of time. Referring to FIG. 3, a DMT modulation system includes multiple constellation encoders 60, the outputs of which are added together to produce the output waveform 68. Each constellation encoder receives a preferably unique set of input bits and encodes a cosine/sine waveform pair as described above with regard to QAM. Each encoder 60 uses a different cosine and sine wave frequency than the other encoders. The output waveform 68 thus comprises multiple frequency components and each frequency component preferably encodes one or more input bits. Each frequency component is referred to as a “frequency bin.”

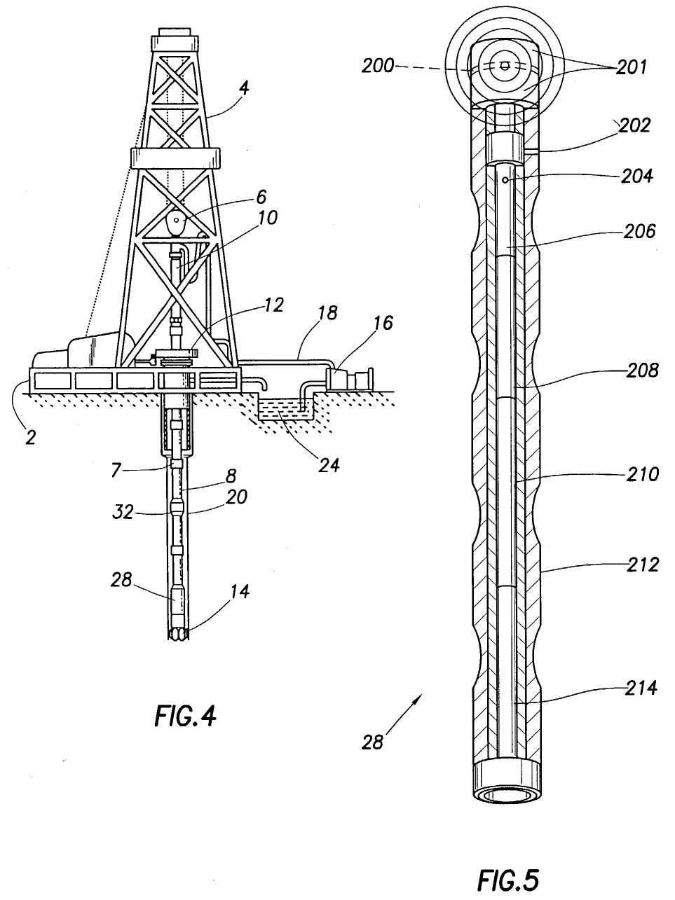

In accordance with the preferred embodiment, the aforementioned DMT modulation technique is applied to downhole telemetry using a wireless medium. Referring now to FIG. 4, a well is shown during drilling operations. A drilling platform 2 is equipped with a derrick 4 that supports a hoist 6. Drilling of oil and gas wells is carried out by a string of drill pipes connected together by “tool” joints 7 so as to form a drill string 8. The hoist 6 suspends a kelly 10 that is used to lower the drill string 8 through rotary table 12. A drill bit 14 connects to the lower end of the drill string 8. The bit 14 is rotated and drilling accomplished by rotating the drill string 8 or by use of a downhole motor near the drill bit, or by both methods. Drilling fluid, termed “mud,” is pumped by mud recirculation equipment 16 through supply pipe 18, through drilling kelly 10, and down the drill string 8 at high pressures and volumes. The mud then emerges through nozzles or jets formed in the drill bit 14. The mud then travels back up the hole via the annulus formed between the exterior of the drill string 8 and the borehole wall 20, through a blowout preventer (not specifically shown), and into a mud pit 24 on the surface. On the surface, the drilling mud is cleaned and then recirculated by recirculation equipment 16. The drilling mud is used to cool the drill bit 14, to carry cuttings from the base of the bore to the surface, and to balance the hydrostatic pressure in the rock formations. However, the system of FIG. 4 is not restricted to the use of mud as a drilling fluid. For example, in the case of under balanced drilling (UBD), other media such as aerated fluids or air/mist mixtures may be preferred over mud.

In a preferred embodiment, a data telemetry system is used in a downhole tool 28 such that MWD is accomplished by wirelessly transmitting data from the downhole tool 28 to the surface and/or in the reverse direction. It should be noted that while downhole tool 28 is shown in close proximity to the drill bit 14, it may be placed at any point along the drill string as desired.

Referring now to FIG. 5, one downhole tool embodiment 28 is shown in more detail. As shown downhole tool 28 includes an insulator 200, antenna 201, annular port 202, internal port 204, electronics module 206, battery module 208, gamma sensor 210, and directional sensor 214, all of which are housed in a drill collar 212. However it should be noted that the contents of downhole tool 28 as shown are not an exhaustive list of its contents as would be evident to one of ordinary skill in the art. Further, as is explained below, the downhole tool 28 may be capable of acoustic transmissions, instead of electromagnetic transmissions.

Employing electromagnetic communications, the insulator 200 separates the upper and lower portions of the antenna 201, and data is transmitted to the surface by inducing an alternating voltage difference across the insulator 200, thereby generating an electromagnetic signal. At the surface, an electromagnetic signal is preferably received as a voltage potential between the conductive drill string and a ground electrode (not shown). One or more repeater modules 32 (FIG. 4) may be provided along the drill string to receive electromagnetic telemetry signals from downhole tool 28 and retransmit them to the surface. The repeater modules 32 preferably include both an electromagnetic telemetry receiver and an electromagnetic telemetry transmitter.

The annular port 202 helps to measure annular pressure, while the internal port 204 helps measure internal pressure. Gamma sensor 210 measures radiation and directional sensor 214 measures the orientation of the drill string. Power is provided to the various sensors and electronics in the downhole tool 28 by the battery module 208. The various measurements from the sensors are reported to the electronics module 206 where they are processed. Processing the signals may include: digitizing analog sensor measurements into binary data, storing the information in local memory, compressing data for efficient transmission, as well as any other tasks evident to one of ordinary skill in the art.

In addition, electronics module 206 contains a modem which includes a transmitter to transmit data preferably using electromagnetic signaling techniques employing DMT modulation. As well as containing a transmitter, the modem may also contain a receiver further enabling uplink and downlink communications via the antenna 201. The modem wirelessly communicates with a surface modem.

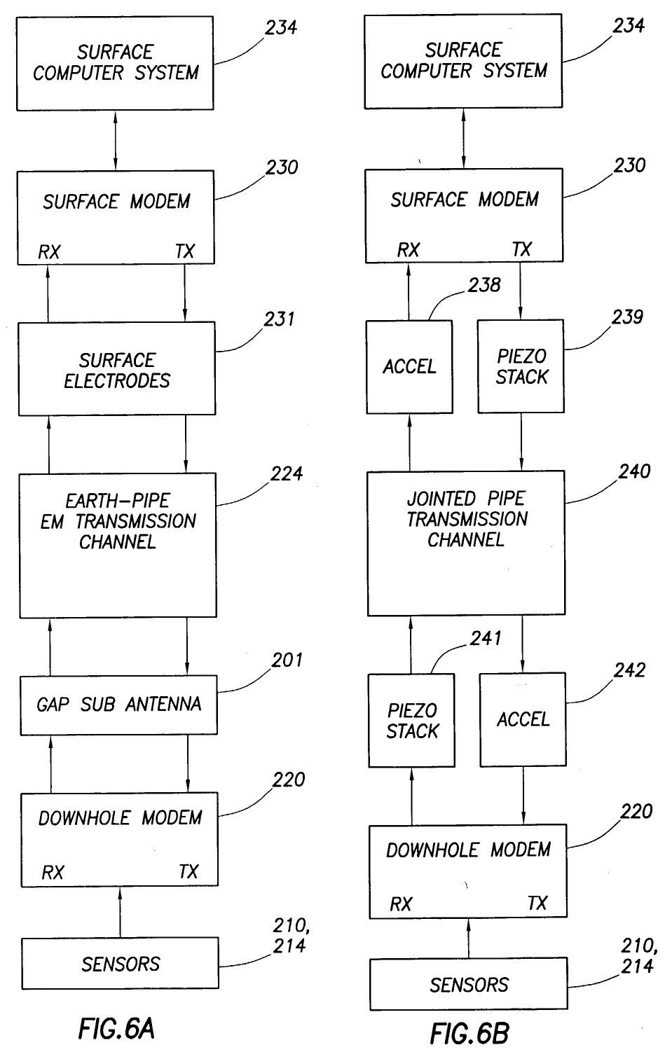

FIGS. 6A and 6B show block diagrams of the wireless telemetry system. FIG. 6A employs electromagnetic communications and FIG. 6B employs acoustic communications. Referring to FIG. 6A, the system includes sensors 210, 214 as discussed above, a downhole modem 220, antenna 201, surface electrodes 231, the transmission channel 224, a surface modem 230 and a surface computer system 234. Signals from the downhole sensors 210, 214 are encoded via a DMT modulation technique in modem 220 and transmitted upward by antenna 201 via the wireless transmission channel 224. The surface modem 230 receives the DMT-modulated signals via the surface electrodes 231 and extracts the original information from the received signal and provides such information to the surface computer 234 for further processing and/or storage.

FIG. 6B is similar to FIG. 6A except that the antenna and electrode arrangement has been replaced with acoustic devices. More specifically, and without limitation, a piezo electric stack 239, 241 is used to generate the acoustic signals. The acoustic signals are then received by accelerometers 238 and 242 which generate electrical signals that are proportional to the acoustic signals.

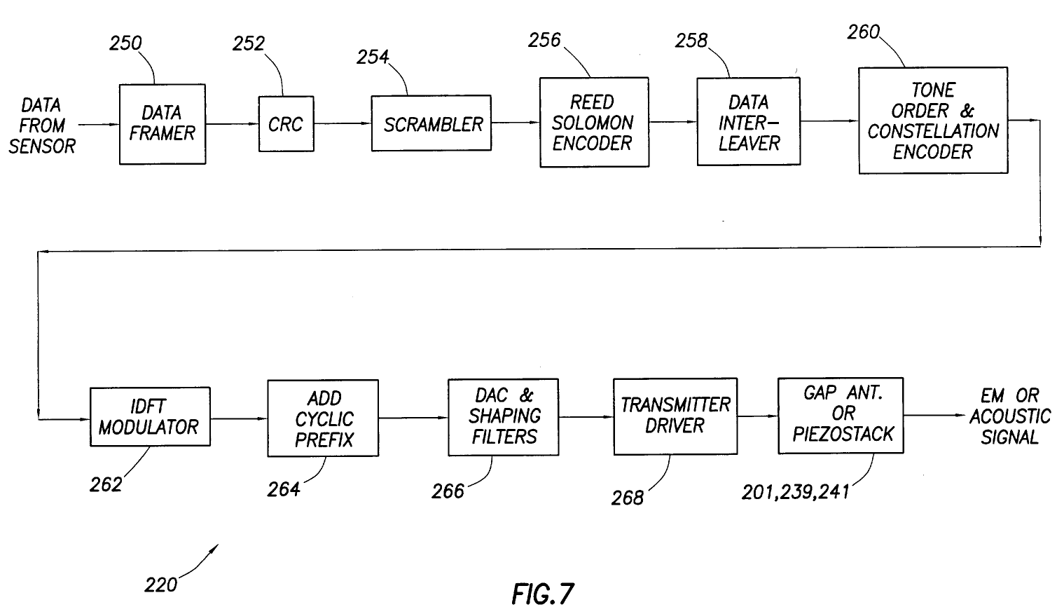

FIG. 7 shows a preferred block diagram of the downhole modem 220 usable for acoustic or electromagnetic communications. The embodiment shown depicts the downhole modem's ability to transmit data to the surface. The surface modem 230 may include a similar architecture to transmit information (such as command and configuration signals) down to the downhole modem. As shown, the modem 220 includes a data framer 250, a CRC generator 252, a scrambler 254, a Reed-Solomon encoder 256, a data interleaver 258, a tone order and constellation encoder 260, an inverse discrete Fourier transform modulator 262, cyclic prefix add logic 264, digital-to-analog converter and shaping filters 266, a transmitter driver 268, and gap antenna/piezo electric stack. Arrangements of these components other than that depicted in FIG. 7 are possible and within the scope of this disclosure.

The data framer 250 arranges the digital data from the sensors into data frames and superframes which comprise groups of frames. The cyclic redundancy checksum (“CRC”) generator 252 preferably adds a CRC byte to each frame or superframe. The CRC byte is a checksum value calculated from the contents of the data frames and provides a mechanism for detecting errors at the receiving end.

The data scrambler alters reorders the data bits according to a generator polynomial which produces a pseudo-random mask. The purpose of the scrambler is to flatten the transmitted frequency spectrum and make it independent of the actual data. After scrambling, the Reed-Solomon encoder 256 adds forward error correction data to the superframe for redundancy. The redundancy may be used by the receiver to detect and correct errors caused by channel interference. A Reed-Solomon code is preferred, but other error correction codes may also be used. The data stream then is interleaved using a convolutional interleaver. The interleaver reorders data stream symbols so as to “spread out” previously adjacent symbols. The interleaver works in conjunction with the Reed-Solomon encoder to make it easier to correct “bursty” sequences of errors.

The tone order and constellation encoder 260 allocates the input bits among the frequency bins and encodes the bits as amplitude values. The number of bits assigned to each bin and the type of QAM coding to be performed preferably were previously decided during modem initialization, as will be described below with respect to FIG. 11. For instance, a frequency bin that contains excessive noise or is more attenuated will be assigned to carry less information than less noisy or less attenuated bins. The number of bits assigned to each frequency bin can also be dynamically varied. The output of the tone order and constellation encoder 260 preferably is N parallel bit streams where N represents the number of frequency bins. After the bits are assigned to each bin, QAM constellation encoding takes place. The encoding technique that takes place is unique for each tone (subchannel). The number of points in each bin's constellation depends on the number of bits assigned to the bin. In accordance with the preferred embodiment, 2 to 15 bits per bin per data symbol are used. The bits assigned to each bin may then be further encoded with a well-known “trellis” coder.

The output signal from the tone order and constellation encoder 260 comprises multiple frequency components which encode the original information to be transmitted. The encoded information is then provided to the inverse discrete Fourier transform (“IDFT”) modulator 262. Modulator 262 uses IDFT as an efficient way to simultaneously create N QAM-modulated carrier frequencies.

The IDFT 262 converts the signal from the frequency domain to the time domain as is well known. A detailed block of the IDFT 262 is shown in FIG. 8. The IDFT 262 includes blocks 282-286. Block 282 adds a complex conjugate suffix to the N bitstreams resulting in 2N bitstreams into the inverse fast Fourier transform block (“IFFT”) 284. The IFFT 284 performs an inverse fast Fourier transform on each 2N points. This is the block in which the data is converted from the frequency domain to the time domain. The parallel-to-serial converter 286 converts the 2N parallel lines of data from the IFFT 284 into serial data that is nearly ready to be transmitted through the transmission channel.

Referring again to FIG. 7, the cyclic prefix logic 264 generally duplicates the end portion of the time domain signal and prepends it to the beginning of the time domain signal. The cyclic prefix 264 is added in order to enable the frequency domain equalization that occurs in the receiver. The digital-to-analog converter (“DAC”) and shaping filters 266 converts the output of the IDFT modulator (with cyclic prefix added) into an analog signal so that it can be transmitted. The shaping filters smooth the signal and shape its spectral content in accordance with known techniques. The signal is then provided to the transmitter driver 228 which drives the signal through GAP antenna or piezo electric stack.

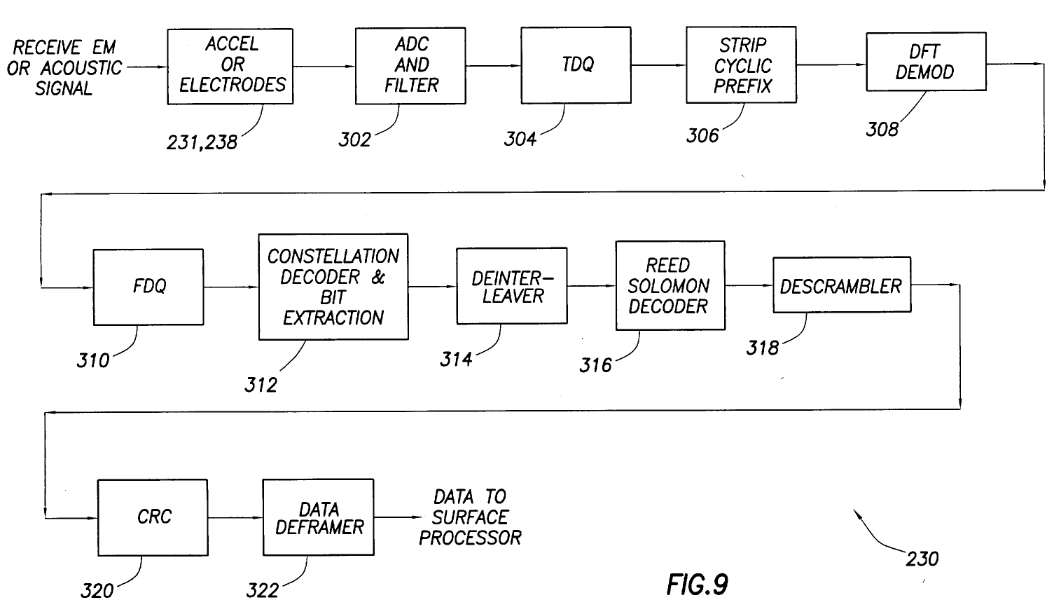

FIG. 9 shows a preferred block diagram of the surface modem 230. The embodiment shown depicts the surface modem's ability to receive data from the downhole modem 220. The downhole modem 220 includes a similar architecture to receive information (such as configuration signals) from the transmitter portion of the surface modem. As shown, the modem 230 includes an accelerometer 238/surface electrodes 231, ADC and filter 302, time domain equalizer (“TDQ”) 304, strip cyclic prefix logic 306, DFT demodulator 308, frequency domain equalizer (“FDQ”) 310, constellation decoder and bit extractor 312, de-interleaver 314, Reed Soloman decoder 316, descrambler 318, CRC 320, and data deframer 322.

The analog-to-digital converter (“ADC”) and filter 302 samples the uplink signal at a sufficiently fast rate to avoid aliasing (e.g., greater than 60 samples per second). Appropriate filtering is also provided.

Although the primary equalization in a DMT system typically is performed in the frequency domain, the TDQ 304 preferably is also present in the front end of the receiving portion of the surface modem 230 in order to shorten the period of intersymbol interference to less than the length of the cyclic prefix. The cyclic prefix added in by cyclic logic 264 (FIG. 7) is stripped out in the receiver following the time domain equalization by strip cyclic prefix logic 306.

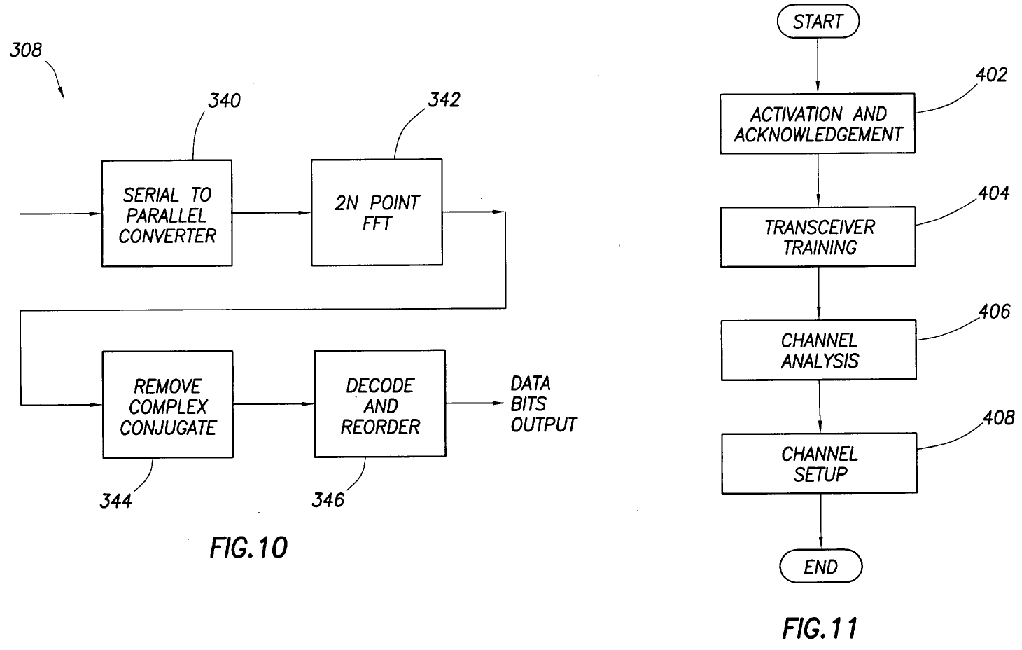

The DFT (discrete Fourier transform) demodulator 308 preferably reverses action of the IDFT modulator 262 of FIG. 7. The DFT modulator 308 converts the signal from the time domain back into the frequency domain. FIG. 10 shows a preferred block diagram of DFT demodulator 308. As shown in FIG. 10, DFT demodulator 308 includes a serial-to-parallel converter 340, a 2N point FFT (fast Fourier transform), and logic 344 to remove the complex conjugate. These blocks perform the inverse of the blocks shown in the IDFT 262 of FIG. 8, as would be well understood by one of ordinary skill in the art.

Referring again to FIG. 9, the FDQ 310 preferably occurs after the DFT demodulator converts the time domain signal to the frequency domain. The frequency domain equalization is accomplished by using one complex multiply for each frequency bin using the output values from the DFT demodulator 308.

After demodulation and equalization, the values for each bin are individually decoded using a QAM constellation decoder and bit extractor 312. Then, the de-interleaver 314 reorders the bytes back into Reed-Solomon code words for processing by the FEC decoder 316. The Reed-Solomon (“RS”) decoder 316 detects and corrects bit errors with the aid of RS check bits added by the RS encoder 256 in the transmitter of the borehole modem 220 (FIG. 7). Further, the descrambler 318 inverts the data scrambling operation performed by the scrambler 254 of the borehole modem 220. The CRC block 320 uses the CRC data generated by the CRC block 252 of the borehole modem 220 to identify superframes that contained an error uncorrectable by the FEC blocks. Finally, the data deframer 322 preferably extracts the encoded data from the ADSL frames and stores the data in memory buffers for subsequent use. Such subsequent use may include processing by the surface computer system 234 (FIG. 6).

The embodiments shown above in FIGS. 7 and 9 for the downhole modem transmitter and surface modem receiver, respectively, are also applicable for transmission of data in the reverse direction. That is, the surface modem 230 may include a transmitter structure as shown in FIG. 7 and the downhole modem may also include a receiver structure as shown in FIG. 9. This permits two-way communication between the downhole and surface modems, although two-way communication is not required.

In accordance with the preferred embodiment of the invention, the communication between surface and downhole electronics undergoes an initialization and training process to configure the DMT for efficient operation. An exemplary embodiment of such an initialization and training process is shown in FIG. 11. The process starts at block 402 which is called the “activation and acknowledgment” phase. During this phase, the modems 220 and 230 are turned on and perform an initial handshake. During this handshake, all signals that are transmitted preferably are single tones at one of the subcarrier frequencies. The downhole modem 220 preferably uses phase locked loops to lock on to the surface modem-generated timing signal.

The next phase 404 is the “transceiver phase” during which several wideband signals are sent between the modems. The wideband signals allow each modem to calculate the upstream and downstream received power spectral density and to adjust the automatic gain control (“AGC”) at each receiver prior to the analog-to-digital conversion. Also, the wideband signals are used to train the equalizers in each receiver. Because there may be multiple downhole modems, the surface modem preferably separately trains each of the downhole modems.

The next phase 406 comprises the “channel analysis” phase. During this phase, capabilities and configuration information preferably is exchanged between the surface modem 230 and the downhole modem 220. The fourth phase 408 is the “channel setup” phase in which the modems 220, 230 decide which upstream and downstream options transmitted in the previous phases will be used. The downhole modem 220 preferably transmits information to the surface modem 230 which allows the surface modem to decide how to configure the downhole modem. The surface modem decides which tones (i.e., frequencies) the downhole transmitter will use and how many bit will be transmitted in each frequency bin. The tones will be distributed to the subsurface transmitters such that the tones preferably are contiguous in frequency for each downhole transmitter. The lowest frequency tones will be assigned to the transmitters associated with sensors and that the number of tones assigned to each downhole transmitter be such that the required data rate requirements for that sensor will be satisfied.

The preferred embodiment provided above describes the use of a discrete multi-tone modulation technique to transmit data between two points in an electromagnetic transmission medium. The two points preferably include a downhole modem and a surface modem in a well borehole, but can be used in a variety of other contexts as well apart from a well. The benefits of such a system include increased telemetry data rate compared to prior techniques for transmitting data in a well borehole as well as increased reliability. The increase in reliability stems from optimally configuring the transmission mechanism (FIG. 11) based on actual measured attenuation conditions present in the borehole transmission channel. The system will generally remain reliable as the borehole conditions change because the system is adaptive.

The following parameters are exemplary of acoustic communications using DMT. The usable acoustic frequency range may be about 1 to 1536 Hz. This frequency range may be divided into 256 subchannels, each being 5 Hz wide, resulting in 116 frequency subchannels within the range of 700 Hz to 1280 Hz which is an acceptable acoustic frequency range for use in DMT.

For an electromagnetic application, the usable frequency range may be, without limitation, 1 to 30 Hz. With 256 subchannels, each individual subchannel would be about 0.1 Hz wide. The aforementioned acoustic and electromagnetic parameters should not be used in any way to limit the scope of this disclosure or the claims which follow unless otherwise specified.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A downhole telemetry system, comprising:
a surface modem coupled to an antenna; and
a downhole modem coupled to an antenna;
wherein said downhole modem communicates with said surface modem using discrete multi-tone modulation to wirelessly transmit telemetry data over a first set of frequency subchannels allocated for uplink communications.

2. The system of claim 1 wherein one or more bits of telemetry are wirelessly transmitted over each subchannel in said first set and a number of bits wirelessly transmitted over each subchannel is determined during a configuration process.

3. The system of claim 1 wherein the telemetry data is transmitted as a dynamically determined number of bits in each of a plurality of the first set of frequency subchannels.

4. The system of claim 1 wherein the number of subchannels in said first set is greater than about 64.

5. The system of claim 1 wherein the number of subchannels in said first set comprises about 256.

6. The system of claim 1 wherein the surface modem wirelessly transmits information to the downhole modem using discrete multi-tone modulation over a second set of frequency channels allocated for downlink communications.

7. The system of claim 6 wherein the number of subchannels in said second set is greater than about 64.

8. The system of claim 6 wherein the number of subchannels in said second set comprises about 256.

9. The system of claim 1 wherein the telemetry data is transmitted via electromagnetic signals.

10. The system of claim 1 wherein the telemetry data is transmitted via acoustic signals.

11. A modem usable in a borehole, comprising:
a constellation encoder;
a modulator coupled to said constellation encoder; and
a driver coupled to said modulator;
wherein said modem is adapted to communicate with another modem using discrete multi-tone modulation to wirelessly transmit telemetry data over a first set of frequency subchannels.

12. The modem of claim 11 wherein one or more bits of telemetry data are wirelessly transmitted over each subchannel in said first set and the number of telemetry data bits wirelessly transmitted over each subchannel is determined during a configuration process.

13. The modem of claim 11 wherein the number of subchannels in said first set is greater than about 64.

14. The modem of claim 11 wherein the number of subchannels in said first set comprises about 256.

15. The modem of claim 11 wherein the modem also includes a constellation demodulator adapted to demodulate information that has been discrete multi-tone modulated over a second set of frequency channels.

16. The modem of claim 15 wherein the number of subchannels in said second set is greater than about 64.

17. The modem of claim 15 wherein the number of subchannels in said second set comprises about 256.

18. The modem of claim 11 wherein the telemetry data is transmitted as electromagnetic signals.

19. The modem of claim 11 wherein the telemetry data is transmitted as acoustic signals.

20. A modem, comprising:
a demodulator; and
a constellation decoder coupled to said demodulator;
wherein said modem is adapted to wirelessly receive, from another modem, signals containing information that has been discrete multi-tone modulated using a first set of frequency subchannels.

21. The modem of claim 20 wherein one or more bits of information are wirelessly received over each subchannel in said first set and the number of bits is determined during a configuration process.

22. The modem of claim 20 wherein the number of subchannels in said first set is greater than about 64.

23. The modem of claim 20 wherein the number of subchannels in said first set comprises about 256.

24. The modem of claim 20 wherein the modem is adapted to wirelessly transmit information that has been discrete multi-tone modulated over a second set of frequency channels.

25. The modem of claim 24 wherein the number of subchannels in said second set is greater than about 64.

26. The modem of claim 24 wherein the number of subchannels in said second set comprises about 256.

27. The modem of claim 20 wherein the signals comprise electromagnetic signals.

28. The modem of claim 20 wherein the signals comprise acoustic signals.

29. A method of communicating in a borehole, comprising:
discrete multi-tone modulating data; and
wirelessly transmitting discrete multi-tone modulated data in said borehole.

30. The method of claim 29 further including wirelessly receiving discrete multi-tone modulated data in said borehole.

31. The method of claim 30 further including demodulating the received discrete multi-tone modulated data.

32. The method of claim 29 wherein the data is wirelessly transmitted as electromagnetic signals.

33. The method of claim 29 wherein the data is wirelessly transmitted as acoustic signals.

34. A method of communicating in a borehole, comprising:
wirelessly receiving discrete multi-tone modulated data in the borehole; and
demodulating the received discrete multi-tone modulated data.

35. The method of claim 34 wherein the data is received as electromagnetic signals.

36. The method of claim 34 wherein the data is received as acoustic signals.
